(19) United States
(12) Patent Application Publication
(10) Pub. No.: US 2006/0100832 A1
(43) Pub. Date: May 11, 2006

(54) Method a designing, engineering modeling and manufacturing orthotics and prosthetics integrating algorithm generated predictions

(76) Inventor: Gerald David Bowman, Winnetka, CA (US)

Correspondence Address: WHITE-WELKER & WELKER, LLC, P.O. BOX 199, CLEAR SPRING, MD, 21722-0199, US

(21) Appl. No.: 10/983,790

(22) Filed: Nov. 8, 2004

(51) Int. Cl. G06F 17/10

(52) U.S. Cl. 703/2

(57) ABSTRACT

The present invention represents an advancement on the current processes involved in designing, engineering, modeling and manufacturing of orthotic and prosthetic devices. Orthotic and prosthetic computer aided design software has the option to apply measurements to a template to create a patient specific model. The use of algorithm generated predictions (also referred to as “AGP”) software takes this functionality and makes it more scientific. Algorithm generated predictions is the process of predicting the appropriate size and shape data through the use of complex algorithms. Certain key pieces of data are entered into the software that then calculates the appropriate dimensions and the appropriate computer aided design template. The dimensions are then applied to the computer aided design template. The computer aided design software modifies the templates by reducing and enlarging areas as necessary and a custom computer aided design model is created that can then be transformed into a physical model for the manufacture of the device.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to orthotics and prosthetics. More specifically the present invention relates to the processes involved in designing, engineering, modeling and manufacturing orthotic and prosthetic devices.

### BACKGROUND OF THE INVENTION

The field of orthotics and prosthetics is an exciting mix of engineering, product design, material science and medical practice. Orthotic and prosthetic professionals evaluate patients with impairment or limb loss for appropriate device(s) to improve their functionality. Many orthotic and prosthetic devices are now pre-made but a significant percentage will always need to be custom designed and manufactured to meet the patient's specific individual anatomy and functional needs. Modern day custom orthotic and prosthetic devices are made of materials that require molding to a rigid model. To ensure a device that conforms and functions appropriately, this model must be an accurate representation of the patient's anatomy and/or accurately represent the shape/size needed to create the required end result.

Patients are referred to orthotic and prosthetic practitioners by physicians and/or insurance companies. A practitioner will evaluate a patient to determine an appropriate design. The design will vary depending on patient current function, patient potential, patient age, patient condition(s), size/shape or other limiting factors. The chosen design will vary by size, shape, complexity and materials. Once a practitioner has determined the design, the process of creating and manufacturing the custom device begins with data acquisition followed by modeling, fabrication, and fitting.

In the prior art there are three known techniques for acquiring patient's size and shape information: measurements/tracings, casting, and digital imaging/scanning. Measurement is the traditional data acquisition method, but is theoretically the least accurate method of those currently used in the prior art. Circumferential and/or diameter measurements are taken at specific anatomical landmarks, along with possibly tracings outlining body contours. This method was the primary method of data acquisition prior to the introduction of molded plastics that required a physical three-dimensional mold for the manufacturing phase.

Measurement/tracing remains the method of choice for “off-the-shelf” and modular braces. These are braces/devices that are pre-made in a variety of sizes, and measurements are used only to choose the appropriate size. Measurements have also become the standard for custom post-operative spinal bracing due to the un-viability of casting a patient post-operatively. Manufacturers keep a library of spinal molds. A mold is selected from this library that most closely approximates the patient measurements. This mold is then modified to better approximate the patient's dimensions and then the brace manufactured.

Although measurement may, at first glance, seem to be accurate, experience shows that considerable inconsistencies arise amongst practitioners. Measurements can be taken at the wrong level, the tape measure could be angulated, and the patient may affect the dimensions simply by his/her posture. For all but the simplest of devices, the shape, size and fit of the device is often compromised by poor measurements.

The casting process involves wetting plaster bandages and then wrapping or laying the plaster bandages onto the body/body part. The plaster reacts with the water and dries to a hard shape. Once removed a negative impression of the body/body part is retained. For spinal bracing and hip bracing/prosthetics this can be an uncomfortable procedure and sometimes embarrassing for female patients. Additionally there is not an “ideal” casting position and its accuracy is greatly affected by the position in which the body/body part is cast. Casting in a horizontal posture is typically an inaccurate representation of the body part. Casting in a horizontal posture can result in posterior “sagging” of the soft tissue thereby producing an inaccurate representation of the body part. Casting in a vertical posture typically results in “roping” as the wet heavy plaster is pulled down by gravity.

While casting is simple, inexpensive, well known and may seem an accurate system, it is very much prone to inconsistency in the quality and accuracy of the cast. It is significantly affected by the skill/experience of the practitioner, with respect to the compression and force applied. Inaccurate joint/body part positioning requires that the cast be “modified” to attempt to improve the alignment. Casting is also relatively time consuming compared to the other techniques.

Several Orthotic and Prosthetic companies have developed computer aided design (also known as “CAD”) software programs that utilize imaging and scanning systems for data acquisition that potentially provide the most accurate patient shape and size information. These systems involve the use of a laser, ultrasound or light to digitally record the 3-dimensional position in space of certain points on the body part. These points are then merged to form a string of numbers representing the 3-dimensional image of the body part. CAD modeling software then presents this string of numbers in a visual format.

While precise shape and size information is essential for some devices, other applications, such as below knee prosthetics and scoliosis bracing, require a shape and size that is not an accurate representation of the body part but a shape/size designed to modify the alignment of all the body segment and thereby produce changes to the shape of the patient. Digital imaging and scanning systems are used by only a small portion of the community due primarily to its high cost and the belief it will take a significant time investment to acquaint oneself with the software.

Digital imaging and scanning techniques typically produce an accurate 3-Dimensional representation of the body part. However they do not allow for applying varying degrees of compression and force to the body part that has proved to be essential for accurate fittings. As practitioners in the field of orthotics and prosthetics typically see a variety of different patients, for which only a few would require the use of digital imaging and scanning, the process can be time consuming as it requires the user to set up the system prior to the data acquisition.

The modeling phase converts the data acquisition information into a model that can be used for the fabrication process. Currently there are two methods for creating models ready for the fabrication process, physical and virtual. The physical method calls for a traditional handcrafted model to be created and modified. This system requires the modeler to have good three-dimensional visualization capabilities. While the physical method system is very inconsistent, it is still the preferred choice for most practitioners.

The virtual system is enhanced by the use of computer-aided design where a three-dimensional representation of the physical model is manipulated by computer aided design computer software. This system allows for similar model modification functions as the physical system but potentially is more accurate and faster. After all of the changes to the patient's model have been finalized, a physical model is carved on a specialized lathe.

The common technique for fabrication found in the prior art of orthotic and prosthetic design and manufacturing requires the use of thermoplastic or thermosetting materials. These materials are molded to the model to create the core structure of a device. The device is then trimmed and the edges are buffed smooth. Straps, padding and attachments are then applied to the device as necessary.

Problems exist with all traditional data acquisition techniques known in the prior art. Regardless of the technique employed, the following factors are limiting factors in the accuracy of the fitting of the device: patients' body sizes change during the day, patients' body sizes change between the date of data acquisition and the fitting of the device, patients' body dimensions will change as a result of wearing the device, the skill/experience of the practitioner.

Unfortunately a patient's anatomy is not an inanimate object of a fixed size but can and will change throughout a day. Patients can typically be more or less swollen in the morning compared to the afternoon. Patients' dimensions can be affected by exercise, stress, diet, time elapsed since last meal, the time a body part has been elevated or depressed and time since injury or operation.

Devices made for patients can be complex and can take several days or even weeks to complete. All the previously mentioned factors can be amplified over a period of several days. A patient's body size can change between the date of data acquisition and the fitting of the device causing fitting problems.

As a result of the forces and compression applied by a device, a patient's body/body parts will change as a result of wearing a device. Current data acquisition techniques have no way to address these changes. Two common examples are the prosthetic limb that will reduce in size as a result of wearing a prosthesis and a scoliosis brace that will reduce a patients' size and change their shape.

Skillful and experienced practitioners learn to vary the amount of compression and force applied to the body part during data acquisition and to modify their readings as they deem appropriate for the individual pressure tolerance and/or the functional needs of the device. This is obviously very subjective and a very limiting factor in the overall effectiveness of devices from the profession as a whole.

What is needed is a method for engineering, modeling, and manufacturing orthotics and prosthetics that reduces or eliminates user error in current data acquisition techniques, provides a faster method than casting and digital imaging/scanning techniques, provides a more scientific and consistent technique for producing variations in shape/size as required by a specific patient's functional needs, is less expensive than current digital imaging/scanning techniques, and reduces modeling and modification time so the patient can receive their orthotic or prosthetic device in a shorter amount of time.

### SUMMARY OF THE INVENTION

In accordance with the present invention a method of designing, engineering, modeling and manufacturing orthotics and prosthetics integrating algorithm generated predictions is provided which overcomes the aforementioned problems of the prior art.

Algorithm generated predictions (also referred to as “AGP”) represents an advancement on the current systems for certain orthotic and prosthetic devices. Orthotic and prosthetic computer aided design software has the option to apply measurements to a template to create a patient specific model. As previously discussed using measurements alone is an inaccurate system. Algorithm generated predictions software takes this functionality and makes it more scientific and more accurate. Algorithm generated predictions is the process of predicting the appropriate size and shape data through the use of complex algorithms. Certain key pieces of data are entered into the software that then calculates the appropriate dimensions and the appropriate computer aided design template. The dimensions are then applied to the computer aided design template. The computer aided design software modifies the templates by reducing and enlarging areas as necessary and a custom computer aided design model is created that can be carved as described.

Most Orthotic and prosthetic CAD software has the option to use measurements as the data acquisition method. These measurements are then applied to a template to create a patient specific model. For prosthetics this is typically seven to ten circumferential measurements and possibly seven to ten ML (width) measurements resulting in between seven and twenty total measurements. For spinal orthotics this is typically, seven circumferential measurements, seven ML measurements and nine length measurements resulting in twenty-three total measurements. However all of these measurements must be accurate for the process to work. It only takes one inaccurate measurement for the system to create an invalid, inaccurate model.

CAD by measurement data acquisition is an inaccurate system, which contains numerous limitations as previously discussed. Algorithm generated predictions software takes this functionality and makes it more scientific and more accurate. Algorithm generated predictions is the process of predicting the appropriate size and shape data through the use of applying complex algorithms to certain key data elements. Algorithm generated predictions can also be used to determine the most appropriate template and suggest manufacturing materials and processes. The key data elements are entered into the software, which then calculates the appropriate patient body part dimensions (dataset) and selects the appropriate CAD template. The dimensions are then applied to the CAD template. The CAD software modifies the templates by reducing and enlarging areas as necessary and a custom CAD model is created that can be exported to CAM software and carved on a lathe as described above.

Algorithm generated predictions work by identifying what the key data elements are for specific body parts/conditions. It then applies complex algorithms to these key data elements to: Create an anticipated complete dataset, specify an allowable range of variations from this dataset, specify anticipated changes to the dataset from device wear; growth; shrinkage; variance in soft tissue compressibility, specify the most appropriate CAD template, and suggest the most appropriate manufacturing materials and processes. It can also be used to calculate accurate estimates of treatment indicators such as progression risk factor, correction resistance factor and expected outcome.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a spinal model template developed by computer aided design software;

FIG. 2a illustrates a spinal model template modified (enlarged and stretched) by the application of measurements;

FIG. 2b illustrates a spinal model template modified (reduced and compressed) by the application of measurements;

FIG. 3 illustrates a spinal model template modified by the application of a patients ‘measured’ measurement set;

FIG. 4 illustrates a spinal model template modified by the application of an algorithm generated predictions measurement set;

FIG. 5 illustrates the graphical user interface of the algorithm generated predictions system and the values that may be entered into the system and a display of calculated values;

FIG. 6 is a flow chart for the data flow entered by a user into the algorithm generated predictions system for producing a sample scoliosis brace;

FIG. 7 is a flow chart for values calculated by the algorithm generated predictions system for producing a sample scoliosis brace.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a method of designing, engineering, modeling and manufacturing orthotics and prosthetics integrating algorithm generated predictions.

Algorithm generated predictions represents an advancement on the current systems for certain orthotic and prosthetic devices. Orthotic and prosthetic computer aided design software has the option to apply measurements to a template to create a patient specific model. As mentioned previously this is an inaccurate system. Algorithm generated predictions software takes this functionality and makes it more scientific. Algorithm generated predictions is the process of predicting the appropriate size and shape data through the use of complex algorithms. Certain key pieces of data are entered into the software that then calculates the appropriate dimensions and the appropriate computer aided design template. The dimensions are then applied to the computer aided design template.

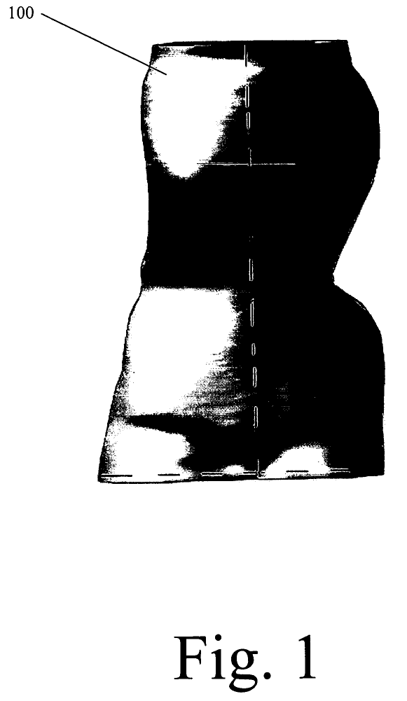

An original spinal model template (100) developed by computer aided design software is illustrated by FIG. 1. The shape of the spinal model template (100) shown represents the template shape before measurements are applied (data acquisition phase).

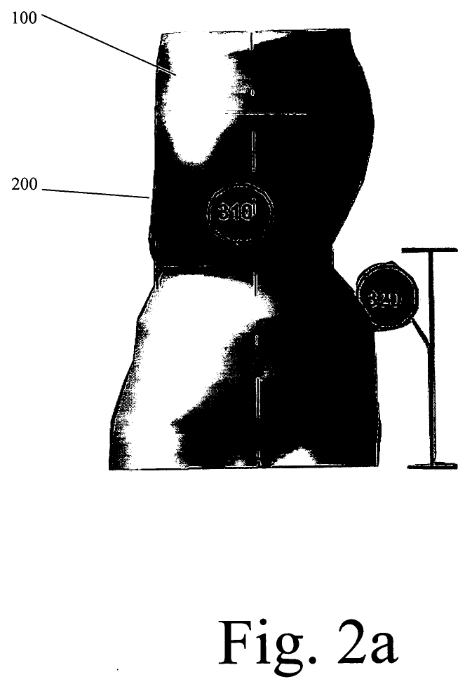

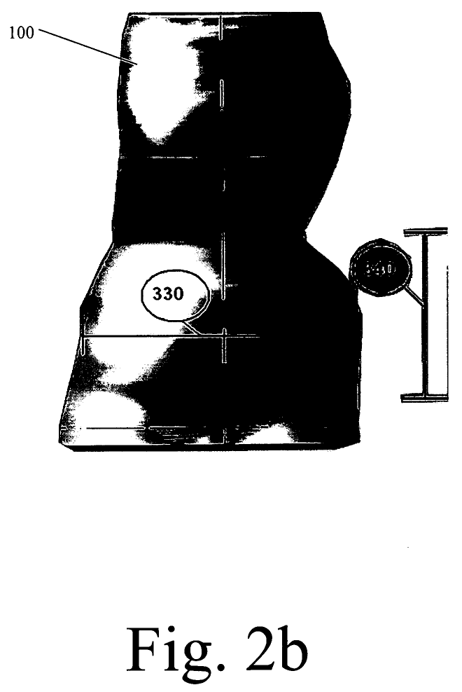

Now referring to FIGS. 2a and 2b, the original spinal model template (100) modified by the application of measurements is shown. The patient's dimensions (200) differ from that of the original template (100), hence the CAD software manipulates the spinal model template (100) by reducing (310), compressing (320), enlarging (330) and stretching (340) areas as necessary to match the measurement set.

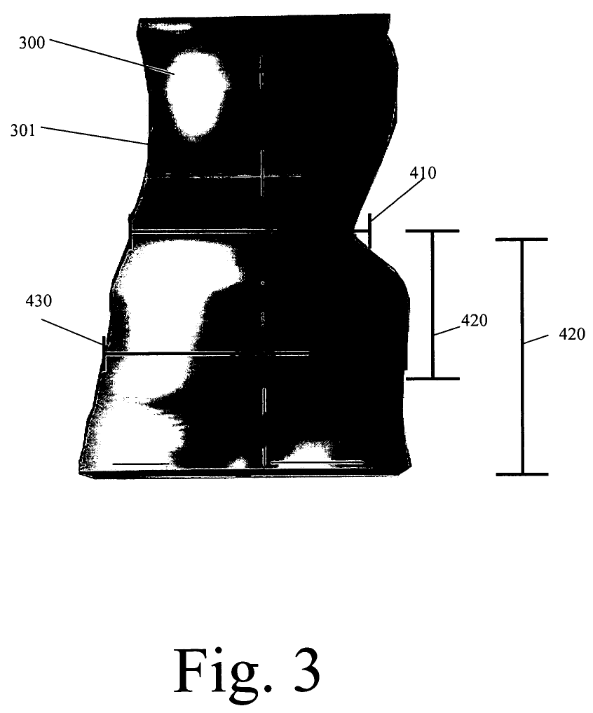

FIG. 3 illustrates the original spinal model template modified by the application of a patient's measurements (301), manually measured by an orthotist. Specifically, changes have been made to the upper shape (410), the torso (420), pelvis (430) and the waist (440) to accommodate for the effects of the patent's specific body size and shape.

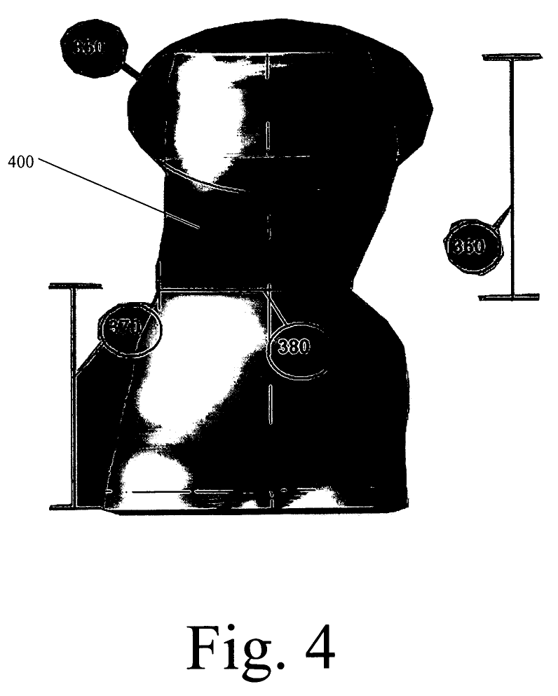

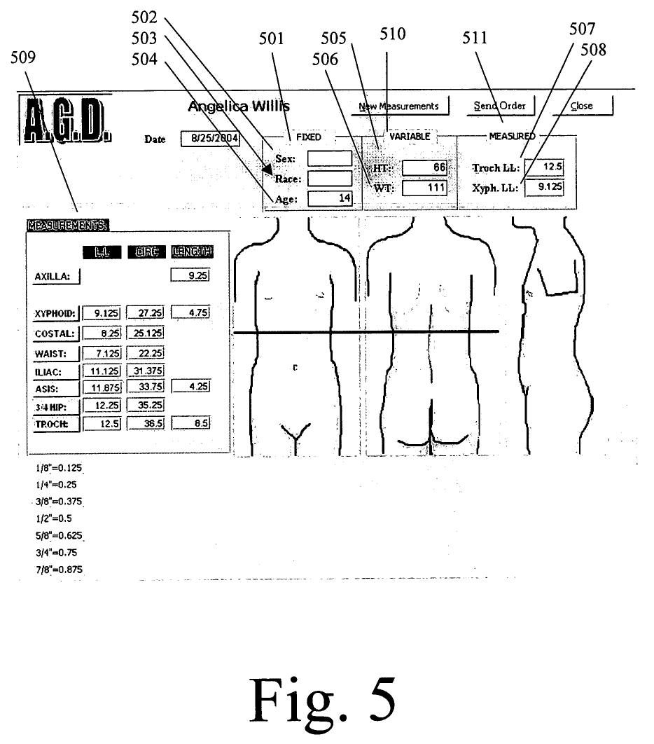

FIG. 4 illustrates the original spinal model template modified by the application of an algorithm generated predictions measurement set (400). A close look at the algorithm generated predictions CAD file (FIG. 5) in comparison to the measurement CAD file of FIG. 3, shows the torso has a more defined upper shape (350), the torso is longer (360), pelvis shorter (370) and the waist reduced (380) to accommodate for the effects of the patient wearing the brace over a long period of time. The algorithm generated predictions software has created a more accurate shape that better approximates the patient's bracing needs.

Now referring to FIG. 5, the computer aided design software modifies the templates by reducing and enlarging areas as necessary and a custom computer aided design model is created that can be carved as described. In a first step, a user enters patient fixed data elements (501) (also referred to as “PFDE”) such as sex (502), race (503), and age (504). In a second step the user enters patient variable data elements (510) (also referred to as “PVDE”) values such as height (505) and weight (506). Next, the algorithm generated dimension software runs algorithms based upon the fixed and variable values to estimate the practitioner measured data elements (511) (also referred to as “PMDE”) values illustrated by Troch. LL (507) and Xyph. LL (508). Next, the user measures the patient and overrides the algorithm generated predictions values for PMDE (511) with a patient's actual values if deemed necessary. The algorithm generated predictions records variances between algorithm generated predictions estimated PMDE (511) values and the ‘measured’ values derived from the user measuring the patient. The algorithm generated predictions then calculates a dataset (509) based upon values of PFDE (501), PVDE (510), variance in estimated PMDE (511) and user entered PMDE (511).

Next the algorithm generated predictions software modifies values to accommodate for other criteria such as: device wear; growth; and shrinkage. The algorithm generated predictions software then selects the appropriate CAD template and suggests the manufacturing materials and processes necessary to create the appropriate device.

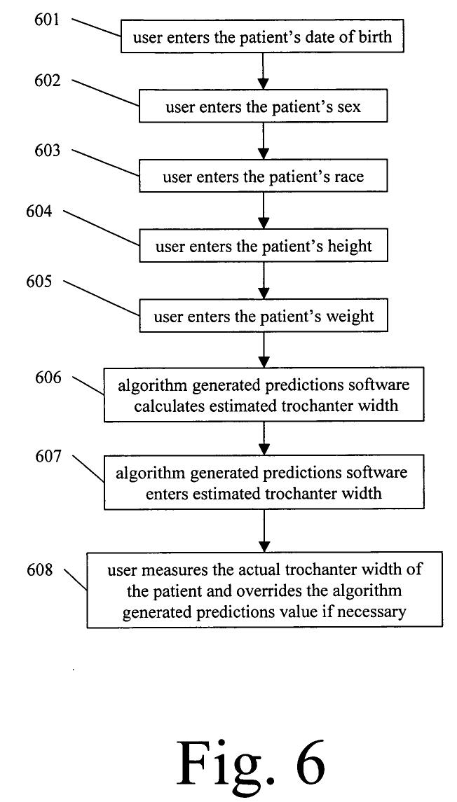

Now referring to FIG. 6 a flow chart for the data to be entered into the algorithm generated predictions system by the user is presented for an example scoliosis brace. In step 601 the user enters the patient's date of birth, in step 602 the user enters the patient's sex, in step 603 the user enters the patient's race, in step 604 the user enters the patient's height, in step 605 the user enters the patient's weight. In step 606 the algorithm generated predictions software calculates estimated trochanter width, in step 607, the algorithm generated predictions software enters estimated trochanter width. In step 608 the user measures the actual trochanter width of the patient and overrides the algorithm generated predictions value if necessary.

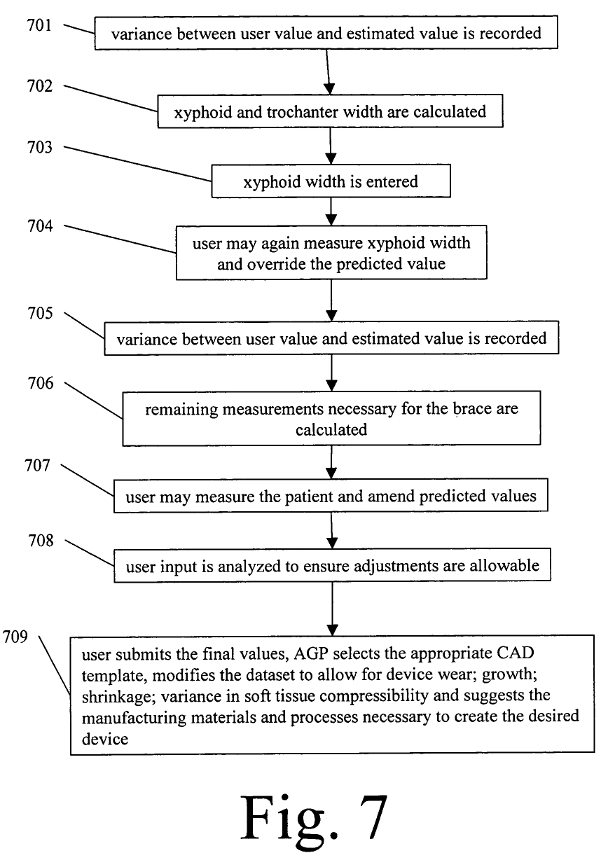

Now referring to FIG. 7, the software of the algorithm generated predictions process is presented for an example scoliosis brace. In step 701 the algorithm generated predictions software records variance between user value and estimated value. In step 702 the algorithm generated predictions software calculates xyphoid width from height, weight and algorithm generated predictions trochanter width and user trochanter width. In step 703 the algorithm generated predictions software enters xyphoid width. In step 704 the user may again measure xyphoid width and override the algorithm generated predictions value. In step 705 the algorithm generated predictions software records variance between user value and estimated value. In step 706 the algorithm generated predictions software calculates the remaining measurements necessary for the scoliosis brace. In step 707 the user may measure the patient and amends said algorithm generated predictions values if deemed appropriate. In step 708 the algorithm generated predictions software analyzes user input to ensure adjustments are allowable. In step 709 the user submits the final values and the algorithm generated predictions software then selects the appropriate CAD template, modifies the dataset to allow for device wear; growth; shrinkage; variance in soft tissue compressibility and suggests the manufacturing materials and processes necessary to create the desired device.

The algorithm generated predictions system incorporates many algorithms and it would be obvious of one of ordinary skill in the art to alter the current algorithms or to create new algorithms for use in the algorithm generated predictions system as an adaptation for the creation of other prosthetic and orthotic devices. One example of such an algorithm is provided for the creation of a scoliosis orthoses dependent on xyphoid width is illustrated as follows:

[BFtr] = (2 * HT + WT) / 200 − 1.27
[WFtr] = [userWGT] − [algorithm generated dimensionsWGT]
If SEX = “M” Then

[algorithm generated dimensionsWX] = [userWGT] − 2 − [WFtr]
If Race = “asian” Then [algorithm generated dimensionsWX] =

[algorithm generated dimensions WX] − 0.375
Else

[algorithm generated dimensionsWX = [userWGT] − 2.5 −

[WFtr] − [BFtr]

If race = “asian” Then [algorithm generated dimensionsWX] =

[algorithm generated dimensionsWX] − 0.25

If race = “black” Then [algorithm generated dimensionsWX] =

[algorithm generated dimensionsWX] − 1.5

If race = “hispanic” Then [algorithm generated dimensionsWX]

= [algorithm generated dimensionsWX] − 0.125

If [userWGT] < 10 Then [algorithm generated dimensionsWX]

= [algorithm generated dimensionsWX] − BFtr / 2

If [userWGT] < 9 Then [algorithm generated dimensionsWX] =

[algorithm generated dimensionsWX] − BFtr / 1.75

If [userWGT] < 8 Then [algorithm generated dimensionsWX] =

[algorithm generated dimensionsWX] − BFtr / 1.5

If [userWGT] < 7 Then [algorithm generated dimensionsWX] =

[algorithm generated dimensionsWX] − BFtr / 1.25
End If

Algorithm generated predictions represents an improvement over the previously defined data acquisition techniques known in the prior art. As previously mentioned, a patient's body size changes during the day and between the date of data acquisition and the date of fitting the device. Algorithm generated predictions are less dependant on actual body part dimensions, instead it determines what the measurements should be for the given patient/body part/condition. Also, a patient's body dimensions will change as a result of wearing a device. Algorithm generated predictions predict the changes that will occur and produces a dataset to account for these changes and/or recommends alternate devices or manufacturing methods to account for the changes.

As algorithm generated predictions generate measurements based upon known data elements (PFDE, PVDE) and easily compiled data elements (PMDE), the skill and experienced of the practitioner becomes less critical. This ensures better fittings, greater consistency throughout the profession and a reduced need for post-fitting modifications and remakes.

Algorithm generated prediction is able to predict what the measurements should be, it will not allow for inaccurate measurements to be added to the system. Fittings are no longer compromised by poor measurement techniques and the process is efficient, fast, and clean compared to those known in the prior art.

Joint positioning with algorithm generated predictions becomes a simple data entry function, i.e. set ankle at 90 degrees. Algorithm generated predictions also predicts shape, thereby preventing shape deformation, that is typical with casting and is a common problem in the prior art. Unlike digital scanning/imaging techniques, algorithm generated predictions also accounts for varying needs of compression and force. Being software based with no hardware requirements means AGP, unlike digital scanning/imaging systems, is an inexpensive system to adopt. Price is no longer a limiting factor in the adoption of a more advanced data acquisition technique. The system also lends itself to be easily integrated into Orthotic and Prosthetic Office Management software to create one seamless package.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. The present invention has currently been developed for scoliosis bracing and trans-tibial (below knee) prosthetics only but it would be obvious to one of ordinary skill in the art to anticipate that the system can also be applied to post-op spinal bracing, trans-femoral prosthetics, ankle-foot orthoses (AFO's), and other equivalent applications of orthotic and prosthetic devices. Thus, the scope of the invention should be determined by the appended claims and their legal equivalents, rather than by the examples given.

The embodiments of the invention in which an exclusive property or privilege is claimed are defined as follows:

1. A method of designing an orthotic device wherein key data elements for a specific body part or condition are identified which are therein applied to a set of complex algorithms.

2. The method of designing an orthotic device of claim 1 wherein the key data elements are applied to the said complex algorithms to:
create an anticipated complete dataset;
specify allowable range variations from said dataset;
specify anticipated changes to said dataset;
specify the most appropriate CAD template from a pre-existing database;
suggest the most appropriate manufacturing materials for a pre-existing database;
suggest the most appropriate manufacturing process for a pre-existing database; and
Estimate treatment indicators such as progression risk factor, correction resistance factor and expected outcome.

3. The method of designing an orthotic device of claim 2 wherein the specific anticipated changes to the dataset comprise changes as a result of device wear, growth, shrinkage, and variance in soft tissue compressibility.

4. The method of designing an orthotic device of claims 2 and 3 wherein to create the anticipated complete dataset three sets of values are used, those being patient fixed data elements, patient variable data elements, and practitioner measured data elements.

5. The method of designing an orthotic device of claim 4 wherein said patient fixed data elements comprise date of birth, sex, and race.

6. The method of designing an orthotic device of claim 4 wherein said patient variable data elements comprise a combination of suitable data elements such as height; weight; body fat; shape type; muscle mass; tissue compressibility; medical condition; amputation date; injury date; surgery date; degree of deformity; previous device; time wearing previous device; shoe size.

7. The method of designing an orthotic device of claim 4 wherein said practitioner measured data elements comprise a combination of suitable data elements such as trochanter width; xyphoid width; torso length; leg length; residual limb length; foot length; foot width; ankle width; knee width.

8. The method of designing an orthotic device of claim 4 wherein any combination of said patient fixed data elements and said patient variable data elements are used to create an estimate for the values for said practitioner measured data elements.

9. Method for designing an orthotic device utilizing a software-assisted process comprising the following steps:
a practitioner enters patient fixed data elements into software program;
said practitioner enters patient variable data elements into software program;
software program utilizes algorithms based upon said patient fixed data elements and said patient variable data elements to provide an estimated practitioner measured data set;
said practitioner measures patient and may change the software generated practitioner measured data set values with actual patient values if desired;
software program records the variance between said estimated practitioner measured data set and actual patient values derived from said practitioner's measurements of said patient;
software program calculates a dataset based upon said patient's fixed data elements, patient's variable data elements, variance in estimated practitioner measured data set and actual patient values derived from said practitioner's measurements of said patient;
practitioner may measure patient to confirm or modify any remaining or additional values determined by the software in the data set;
practitioner communicates to software that the displayed values are those desired;
software program modifies values to accommodate for other criteria;
software program selects appropriate template;
software program suggests manufacturing material;
software program suggests manufacturing process;
software program suggest treatment indicators such as progression risk factor,
correction resistance factor and expected outcome.

10. The method of designing an orthotic device of claim 9 wherein said patient variable data elements comprise a combination of suitable data elements such as height; weight; body fat; shape type; muscle mass; tissue compressibility; medical condition; amputation date; injury date; surgery date; degree of deformity; previous device; time wearing previous device; shoe size.

11. The method of designing an orthotic device of claim 9 wherein said practitioner measured data elements comprise a combination of suitable data elements such as trochanter width; xyphoid width; torso length; leg length; residual limb length; foot length; foot width; ankle width; knee width.
